(19) United States
(12) Patent Application Publication
(10) Pub. No.: US 2005/0190688 A1
(43) Pub. Date: Sep. 1, 2005

(54) Code generation, in particular for umts digital communications

(75) Inventors: Eric Batut, Vizille (FR); Benoit Miscopein, Grenoble (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM, Paris (FR)

(21) Appl. No.: 10/514,467

(22) PCT Filed: Apr. 18, 2003
(86) PCT No.: PCT/FR03/01249

§ 371 Date: Nov. 15, 2004

(30) Foreign Application Priority Data
May 15, 2002 (FR) 02/06006

(51) Int. Cl. H04J 11/00

(52) U.S. Cl. 370/203

(57) ABSTRACT

One element in one of several orthogonal OVSF codes with at most 2^{BM} elements is generated dynamically by deriving an intermediate word having (1) B least significant bits identical to the least significant bits in the reverse order of a word representing a code number SF=2^{B} and (2) BM−B most significant bits having predetermined state. An AND circuit multiplies the bit in the intermediate word and a word representing a determined position of the element in the code produces a BM-bit product word. An EXCLUSIVE-OR operation on the bits of the product word generates the code element.

The present invention concerns in a general way the generation of coding signals for code division multiple access (CDMA) digital communications in a base station or a mobile station of a system of simultaneous transmissions at different bit rates, for example a cellular radiotelephone system. The invention concerns more particularly the generation of orthogonal variable spreading factor (OVSF) codes conforming to the Universal Mobile Telecommunications System (UMTS) standard in time division duplex (TDD) or frequency division duplex (FDD) mode, typically in the emitter or the receiver of a station over an uplink or a downlink.

For example, a TDD mode frame conforming to the UMTS mobile telephony standard comprises timeslots of predetermined duration and each including U simultaneous bursts of data, usually respectively assigned to U users. A code (channelisation code) for a burst allocated to a given user is constituted of a sequence of SF code elements (chips) associated with each complex symbol to be transmitted, where U≦SF. The code elements are in non-return to zero (NRZ) code whose values are +1 and −1. The length of each code, called the spreading factor, expressed as a number of code elements is equal to a power of 2 lying between 4=2² and 512=2⁹. The spreading factor may vary in a station, in particular as a function of the bit rate, also variable, requested for a user; for example, a code for a given bit rate has a length equal to the half-length of a code for half the given bit rate.

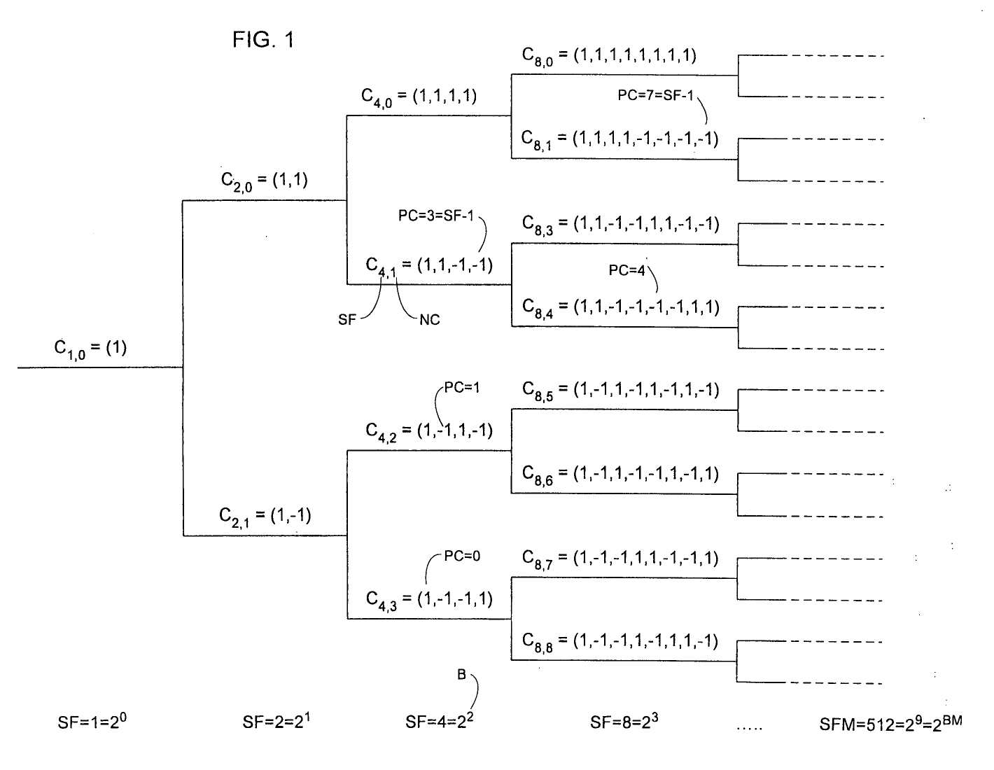

The codes are traditionally generated by an iterative process reproducing a tree structure of the OVSF codes concerned, as shown schematically in FIG. 1, in which the set of codes concerned is denoted
{C_{SF,NC}}_{SF=2}_{^{k}},kε[0,9],NCε[0,SF−1]
The iterative process is governed by the following equations:

$$\begin{matrix}{C}_{1 , 0} = ( 1 ) \\ {C}_{2 , 0} = ( 1 , 1 ) \\ {C}_{2 , 1} = ( 1 , - 1 ) \\ … \\ {\{ {C}_{SF , NC} \}}_{NC ∈ [ 0 , SF - 1 ]} = ( \begin{matrix}{C}_{SF , 0} \\ {C}_{SF , 1} \\ ⋮ \\ {C}_{SF , SF - 2} \\ {C}_{SF , SF - 1}\end{matrix} ) = ( \begin{matrix}{C}_{SF / 2 , 0} {C}_{SF / 2 , 0} \\ {C}_{SF / 2 , 0} {\tilde{C}}_{SF / 2 , 0} \\ ⋮ \\ {C}_{SF / 2 , SF / 2 - 1} {C}_{SF / 2 , SF / 2 - 1} \\ {C}_{SF / 2 , SF / 2 - 1} {\tilde{C}}_{SF / 2 , SF / 2 - 1}\end{matrix} ) ,\end{matrix}$$

in which \tilde{C}_{SF,sf} designates the code whose elements have values opposite to those of the elements of the code C_{SF,sf}:
∀SF,∀sf ε[0,,SF−1], \tilde{C}_{SF,sf}=−C_{SF,sf}

In the emitter at the radio interface of a station, a spreading modulator processes the successive complex symbols leaving a QPSK phase modulator to produce the code associated with a user and modulating the real and imaginary components of each symbol to be applied to a scrambler before being filtered, amplified and transposed in frequency. For each user, a code is written in a code memory at the beginning of a call with that user and may be modified as a function of a code modification request during the call. Thus two memories are provided: a table of the correspondences between the user identification numbers and the code numbers and a table of the correspondences between the code numbers and the codes. Typically, for at least 2⁹=512 codes each having 512 code elements, the capacity of the second memory must be at least

$${\sum }_{B = 2}^{B = 9} {2}^{2 B} = 349520 bits ,$$

i.e. 43 kbytes.

Thus the codes must be generated before they are used and necessitate a memory space for storing them.

The invention aims to, obviate these drawbacks by generating codes directly as and when calls proceed in a station, without using any second memory establishing the correspondence between a code number and a code, i.e. without memorizing the codes.

Accordingly a device according to the invention for generating at most SFM=2^{BM} orthogonal codes each comprising at most SFM code elements, BM being an integer, generates a code element thanks to the following means. The device receives a word representative of a determined position of the code element in a code, a word representative of the code number designating the code from SF=2^{B} possible codes with SF elements and a word representative of a number allocated to the number SF of elements of the code, B being an integer such that B≦BM. The device comprises logic means for supplying an BM-bits intermediate word in which B less significant bits are the B less significant bits in the reverse order in the code number word and BM−B more significant bits are all in a predetermined state, means for respectively multiplying the bits having the same rank in the intermediate word and the position word to produce a BM-bits product word, and means for applying an EXCLUSIVE-OR operation to all the bits of the product word in order to generate the code element.

Thus the elements of a code are generated dynamically by logic means with no code memory. More generally, the codes are generated dynamically by the device of the invention in response to permanent requests at high frequency associated with traffic channels occupied by calls between a fixed or mobile station including the device and another mobile or fixed station.

The device of the invention advantageously has a relatively small size by virtue of microcircuit design and may be included more than once in the same station in order to generate a plurality of orthogonal codes simultaneously and in an independent fashion.

According to a preferred embodiment, the logic means comprises means for reversing the order of the bits of the code number word into a reversed word, means for determining the difference BM−B, and means for shifting by BM−B positions toward the less significant bits the B more significant bits of the reversed word in order to form the intermediate word with bits in the predetermined state as BM−B more significant bits and with the B more significant bits of the reversed word as B less significant bits.

According to a special embodiment directed towards the UMTS standard BM=9, and B=0 and B=1 are prohibited values, and the difference determining means consists in means for inverting the state of the bits of the word representative of the number allocated to the number of code elements into a shift parameter word to be applied to the shifting means.

Other features and advantages of the present invention will become more clearly apparent on reading the following description of a plurality of preferred embodiments of the invention with reference to the corresponding appended drawings, in which:

FIG. 1 is a tree diagram of the prior art iterative OVSF orthogonal codes process; and

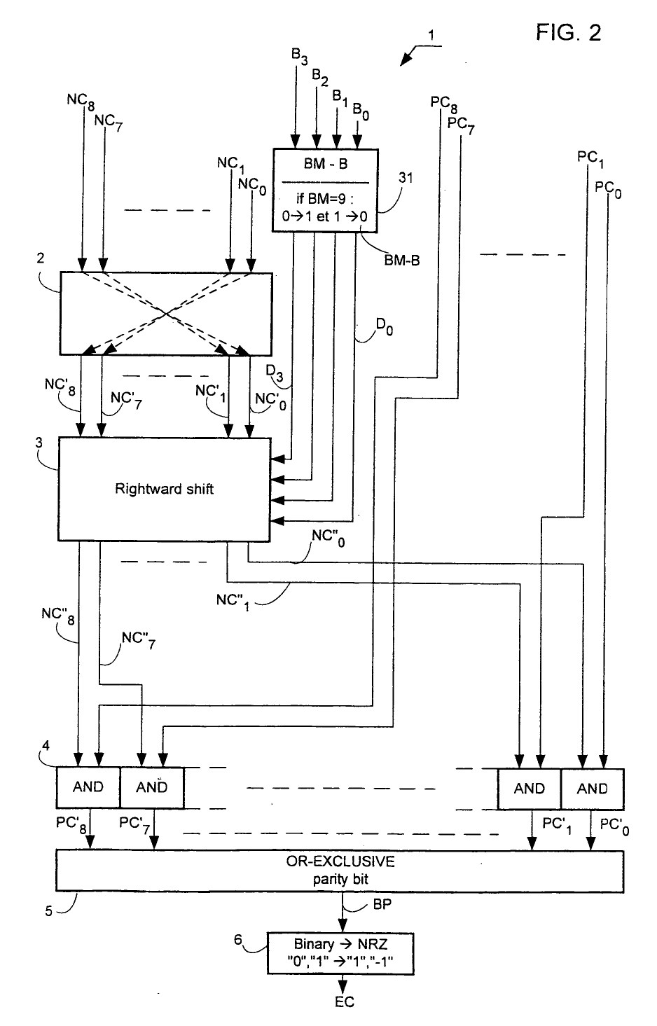

FIG. 2 is a block diagram of an OVSF orthogonal code generation device according to the invention.

The code generation device according to the invention is included in a spreading modulator of the emitter for example of a base station and aims to generate codes including a maximum of SFM bits. For the UMTS standard, the maximum number of bits SFM is equal to 512=2⁹⁼²^{BM}.

In the remainder of the description, a binary word M comprising BM bits is designated by the bits M_{BM-1}, M_{BM-2}, . . . M₂, M₁, M₀; M_{BM-1} and M₀ being the most significant bit and the least significant bit of the word M. The logic functions defined hereinafter are implemented in positive logic by way of example.

As shown in FIG. 2, the code generation device 1 essentially comprises three data input ports through which it receives three binary words representative of integer numbers PC, B and NC that are sufficient to generate a binary code element EC, finally converted into non-return to zero (NRZ) code.

The first word is representative of a determined position PC of the code element EC in a given code (channelisation code) and is provided by a timebase in the modulator. The position of a code element being comprised between 0 and the length SF−1 of the code, and more generally able to vary from 0 to SFM−1=2⁹−1=511, the word PC comprises BM=9 bits PC_{BM-1} to PC₀.

The second and third words are provided by a correspondence table equivalent to the first memory cited above in the modulator in response to the identification number of a given user. The second word is representative of the number NC of the given code that designates the code from the SF=2^{B} possible codes with SF elements and which is therefore from 0 to SF−1. Since SF is at most equal to SFM, the number of bits NC_{BM-1} to NC₀ of the word NC also comprises BM=9 bits and the number may take 2^{BM}=512 values. The third word is representative of the spreading factor SF of the given code, equal to the number of elements in the given code, where SF=2^{B} and the integer B such that B≦BM.

In fact, the number of bits in the third word is at most equal to the maximum number of bits necessary for designating the BM spreading factors SF, i.e. for successively numbering the BM spreading factors respectively equal to the lengths of the codes varying from 2 to 2^{BM} in successive powers of 2. The number of bits of the third word is therefore equal to the integer portion of log₂(2×BM−1). The two columns of the next correspondence table 1 establish the correspondence of the 4=integer part (log₂ 17) bits B₃, B₂, B₁ and B₀ of the third word and the spreading factor SF for BM=9:

TABLE 1

| SF = 2^{B} | B₃, B₂, B₁, B₀ | D = BM − B | D₃, D₂, D₁, D₀ |
|---|---|---|---|
| 1 | 0000 | 9 | 1001 |
| 2 | 0001 | 8 | 1000 |
| 4 | 0010 | 7 | 0111 |
| 8 | 0011 | 6 | 0110 |
| 16 | 0100 | 5 | 0101 |
| 32 | 0101 | 4 | 0100 |
| 64 | 0110 | 3 | 0011 |
| 128 | 0111 | 2 | 0010 |
| 256 | 1000 | 1 | 0001 |
| 512 | 1001 | 0 | 0000 |

It is shown that the code element EC to be generated is deduced from the following logic equation:
EC=XOR(AND(SHR(REV(NC,BM),BM-SF),PC)).

REV, SHR, AND and XOR designate logic operations that are respectively effected by logic circuits 2, 3, 4 and 5 included in the code generation device 1, as shown in FIG. 2.

The circuit 2 implements the REV (REVerse) function in order to reverse the order of the bits NC₀ to NC_{BM-1} of the word representative of the code number NC. The circuit 2 supplies a reversed word NC′ whose bits NC′_{BM-1} to NC′₀ are respectively identical to the bits NC₀ to NC_{BM-1}, as indicated in detail hereinafter for BM=9:

| | |
|---|---|
| NC | (NC₈, NC₇, NC₆, NC₅, NC₄, NC₃, NC₂, NC₁, NC₀) |
| NC′ | (NC′₈, NC′₇, NC′₆, NC′₅, NC′₄, NC′₃, NC′₂, NC′₁, NC′₀) = (NC₀, |
| | NC₁, NC₂, NC₃, NC₄, NC₅, NC₆, NC₇, NC₈) |

The circuit 3 is a programmable rightward shift register for shifting to the right, i.e. toward the less significant bits, the more significant bits of the reversed word NC′. The circuit 3 implements an SHR (SHift Right) function in which the shift is equal to the difference BM−B produced by a difference determination circuit 31. To the circuit 31 is applied the word B₃,B₂,B₁,B₀ with 4=integer part of log₂(2BM−1) bits representative of the exponent B of the power of 2 equal to the spreading factor SF, i.e. the number B of the spreading factor from the BM spreading factors, i.e. from the BM stages of the tree structure shown in FIG. 1. The numbers B from 1 to BM of spreading factors are ordered in increasing order of the spreading factors SF.

The circuit 31 calculates the difference BM−B to supply a shift parameter word on 4 bits D₃, D₂, D₁, D₀, as indicated in the third and fourth columns of the above table 1, to be applied as shift parameters D to the circuit 3. The circuit 3 supplies an intermediate word NC″ with BM bits NC″_{BM-1} to NC″₀ whose B less significant bits are the B more significant bits of the reversed word NC′ and therefore the B less significant bits in the reverse order in the word representative of the code number NC and whose BM−B more significant bits are bits in the predetermined binary state “0”, in accordance with the following table for BM=9:

| | D = | (NC″₈, NC″₇, NC″₆, NC″₅, NC″₄, |
|---|---|---|
| B-1 | BM − B | NC″₃, NC″₂, NC″₁, NC″₀) |
| 0000 | 1000 | (0, 0, 0, 0, 0, 0, 0, 0, NC′₈) = (0, |
| | | 0, 0, 0, 0, 0, 0, 0, NC₀) |
| 0001 | 0111 | (0, 0, 0, 0, 0, 0, 0, NC′₈, NC′₇) = (0, |
| | | 0, 0, 0, 0, 0, 0, NC₀, NC₁) |
| 0010 | 0110 | (0, 0, 0, 0, 0, 0, NC′₈, NC′₇, NC′₆) = (0, |
| | | 0, 0, 0, 0, 0, NC₀, NC₁, NC₂) |
| 0011 | 0101 | (0, 0, 0, 0, 0, NC′₈, NC′₇, NC′₆, NC′₅) = (0, |
| | | (0, 0, 0, 0, NC₀, NC₁, NC₂, NC₃) |
| 0100 | 0100 | (0, 0, 0, 0, NC′₈, NC′₇, NC′₆, NC′₅, NC′₄) = (0, |
| | | 0, 0, 0, NC₀, NC₁, NC₂, NC₃, NC₄) |
| 0101 | 0011 | (0, 0, 0, NC′₈, NC′₇, NC′₆, NC′₅, NC′₄, NC′₃) = (0, |
| | | 0, 0, NC₀, NC₁, NC₂, NC₃, NC₄, NC₅ ) |
| 0110 | 0010 | (0, 0, NC′₈, NC′₇, NC′₆, NC′₅, NC′₄, NC′₃, NC′₂) = (0, |
| | | 0, NC₀, NC₁, NC₂, NC₃, NC₄, NC₅, NC₆) |
| 0111 | 0001 | (0, NC′₈, NC′₇, NC′₆, NC′₅, NC′₄, |
| | | NC′₃, NC′₂, NC′₁) = (0, |
| | | NC₀, NC₁, NC₂, NC₃, NC₄, NC₅, NC₆, NC₇) |
| 1000 | 0000 | (NC′₈, NC′₇, NC′₆, NC′₅, NC′₄, NC′₃, |
| | | NC′₂, NC′₁, NC′₀) = (NC₀, |
| | | NC₁, NC₂, NC₃, NC₄, NC₅, NC₆, NC₇, NC₈) |

In practice, the UMTS standard prohibits the use of values SF≦2 and B=0 and B=1, i.e. the use of the first stage with two codes in the tree structure from FIG. 1. The spreading factor SF has only BM−1=8 possible values 2²=4 to 2⁹=2^{BM}. The number B−2 of the spreading factor may then vary from 0 to BM−2 so that the word representative of the number of the spreading factor SF comprises only 3=integer part log₂(2.8−1) bits. The spreading factor number word, thus with 3 bits B₂,B₁,B₀, instead of 4 bits, is applied to the input port of the circuit 31. Instead of establishing the difference D=BM−B directly, as before, the circuit 31 preferably executes a function equivalent to this difference by determining the “1”'s complement, i.e. by inverting the state of each bit of the incoming word of 3 bits in accordance with the first two columns of the following table whose third column indicates the corresponding intermediate word NC″ at the output of the shift circuit 3:

| | | (NC″₈, NC″₇, NC″₆, NC″₅, NC″₄, |
|---|---|---|
| B-2 | D | NC″₃, NC″₂, NC″₁, NC″₀) |
| 000 | 111 | (0, 0, 0, 0, 0, 0, 0, NC′₈, NC′₇) = (0, |
| | | 0, 0, 0, 0, 0, 0, NC₀, NC₁) |
| 001 | 110 | (0, 0, 0, 0, 0, 0, NC′₈, NC′₇, NC′₆) = (0, |
| | | 0, 0, 0, 0, 0, NC₀, NC₁, NC₂) |
| 010 | 101 | (0, 0, 0, 0, 0, NC′₈, NC′₇, NC′₆, NC′₅) = (0, |
| | | 0, 0, 0, 0, NC₀, NC₁, NC₂, NC₃) |
| 011 | 100 | (0, 0, 0, 0, NC′₈, NC′₇, NC′₆, NC′₅, NC′₄) = (0, |
| | | 0, 0, 0, NC₀, NC₁, NC₂, NC₃, NC₄) |
| 100 | 011 | (0, 0, 0, NC′₈, NC′₇, NC′₆, NC′₅, NC′₄, NC′₃) = (0, |
| | | 0, 0, NC₀, NC₁, NC₂, NC₃, NC₄, NC₅) |
| 101 | 010 | (0, 0, NC′₈, NC′₇, NC′₆, NC′₅, NC′₄, NC′₃, NC′₂) = (0, |
| | | 0, NC₀, NC₁, NC₂, NC₃, NC₄, NC₅, NC₆) |
| 110 | 001 | (0, NC′₈, NC′₇, NC′₆, NC′₅, NC′₄, NC′₃, NC′₂, NC′₁) = (0, |
| | | NC₀, NC₁, NC₂, NC₃, NC₄, NC₅, NC₆, NC₇) |
| 111 | 000 | (NC′₈, NC′₇, NC′₆, NC′₅, NC′₄, |
| | | NC′₃, NC′₂, NC′₁, NC′₀) = (NC₀, |
| | | NC₁, NC₂, NC₃, NC₄, NC₅, NC₆, NC₇, NC₈) |

The circuit 4 combines two by two respectively the BM bits of weight 0 to BM−1 in the intermediate word NC″ and the BM bits of weight 0 to BM−1 in the word representative of the position PC of the code element to be generated, using BM respective AND gates with two inputs. The BM−B first operations AND produce more significant bits PC′_{BM-}1 to PC′_{BM-B} of an intermediate product in the predetermined state “0”, and the remaining B operations AND produce less significant bits PC′_{BM-B-1}=(NC″_{BM-B-1}×PC_{BM-B-1}) to PC′₀=(NC″₀×PC₀) of the intermediate product.

The circuit 5 determines a parity bit BP of the intermediate product equal to the code element EC in binary to be generated. The parity bit BP is in the state “1” when the number of “1” bits in the intermediate product word PC′_{BM-1} to PC′₀ is odd and the state “0” when the aforementioned number of “1” bits is even. The circuit 5 includes an EXCLUSIVE-OR gate with BM inputs for applying the EXCLUSIVE-OR operation to 3 bits of the intermediate result word, that is to say:
BP=PC′_{BM-1}⊕PC′_{BM-2}⊕ . . . ⊕PC′₂⊕PC′₁⊕PC′₀.

Finally, the code generation device 1 comprises a binary to non-return to zero code converter 6 for converting the binary state “0” or “1” of the parity bit BP into the generated code element EC “1” or “−1” to be applied to the spreading data input of the scrambler referred to in the preamble of the description.

In practice, the code generation device 1 is designed in the form of a programmable logic circuit or an application-specific integrated circuit (ASIC) logic circuit. It constitutes a circuit of very small size in order for a plurality of devices 1 to be installed in parallel in a fixed or mobile station of a UMTS cellular radiotelephone network to generate simultaneously OVSF orthogonal codes.

1-4. (canceled)

5. A device for generating at most SFM=2^{BM} orthogonal codes each comprising at most SFM code elements, BM being an integer,
said device being adapted to receive (a) position word representative of a determined position of said code element in a code, (b) a code number word representative of a code number designating said code from SF=2^{B} possible codes with SF elements and (c) a word representative of a number allocated to the number SF of elements of said code, B being an integer such that B≦BM, and
said device comprising processor circuitry for (a) deriving a BM-bit intermediate word, the B least significant bits of intermediate word being the least B significant bits in the reverse order of the code number word and the BM−B most significant bits of intermediate word being all in a predetermined state, (b) for respectively multiplying the bits having same ranks in said intermediate word and said position word to produce a BM-bit product word, and (c) for generating said code element by applying an EXCLUSIVE-OR operation to all the bits of said product word.

6. The apparatus of claim 5, wherein the processor circuitry is arranged for (a) reversing the order of the bits of said code number word into a reversed word, (b) determining the difference BM−B, (c) shifting the B most significant bits of said reversed word by BM−B positions toward the least significant bits, and (d) forming said intermediate word with bits in the predetermined state as the BM−B most significant bits and with the B most significant bits of said reversed word as the B least significant bits.

7. The device of claim 6, wherein the processor circuitry is arranged for forming the intermediate word by shifting the B most significant bits of said reversed word by BM−B positions toward the least significant bits.

8. A device according to claim 6, wherein BM=9 and B=0 and B=1 are prohibited values, and said processor circuitry is arranged for determining the difference by inverting the state of the bits of said word representative of the number allocated to said number of code elements into a shift parameter word for causing said shifting operation.

9. A device according to claim 5, wherein the processor circuitry is arranged for performing a binary-non-return to zero operation on the output of said EXCLUSIVE-OR operation.

10. A base station for code division multiple access digital communications including a code generation device for generating at most SFM=2_{BM} orthogonal codes, each comprising at most SFM code elements, BM being an integer,
said code generation device being arranged to receive (a) a position word representative of a determined position of said code element in a code, (b) a code number word representative of a code number designating said code from SF=2^{B} possible codes with SF elements and (c) a word representative of a number allocated to the number SF of elements of said code, B being an integer such that B≦BM, and
said code generation device comprising processing circuitry for (a) deriving a BM-bit intermediate word such that the B least significant bits of the intermediate word are the B least significant bits in the reverse order in the code number word and the BM−B most significant bits of the intermediate word all have predetermined state, (b) respectively multiplying the bits having the same ranks in said intermediate word and said position word to produce a BM-bit product word, and (c) generating said code element by applying an EXCLUSIVE-OR operation to all the bits of said product word.

11. A method of generating at most SFM=2^{BM} orthogonal codes, each including at most SFM code elements, BM being an integer, said method being performed in response to: (a) position word representative of a determined position of said code element in a code, (b) a code number word representative of a code number designating said code from SF=2^{B} possible codes with SF elements, and (c) a word representative of a number allocated to the number SF of elements of said code, B being an integer such that B≦BM,
the method comprising:
(a) deriving a BM-bit intermediate word, the B least significant bits of intermediate word being the least B significant bits in the reverse order of the code number word and the BM−B most significant bits of intermediate work being all in a predetermined state, (b) respectively multiplying the bits having same ranks in said intermediate word and said position word to produce a BM-bit product word, and (c) generating said code element by applying an EXCLUSIVE-OR operation to all the bits of said product word.

12. A method of generating at most SFM=2^{BM} orthogonal codes used in code division multiple access digital communications, each code having at most SFM code elements, BM being an integer,
said method being performed in response to (a) a position word representative of a determined position of said code element in ac ode, (b) a code number word representative of a code number designating said code from SF=2^{B} from possible codes with SF elements and (c) a word representative of a number allocated to the number SF of elements of said code, B being an integer such that B≦BM, and
said method comprising
(a) deriving an BM-bit intermediate word in which the B least significant bits of the intermediate word are the B least significant bits in the reverse order of the code number word and the BM−B most significant bits of the intermediate word all have a predetermined state,
(b) producing a BM-bit product word by respectively multiplying the bits having the same ranks in said intermediate word and said position word to produce, and
(c) generating one of said code elements by applying an EXCLUSIVE-OR operation to all the bits of said product word.

13. Performing the method of claim 12 at a base station.

14. Performing the method of claim 12 at a mobile station.

15. The method of claim 12 further including reversing the order of the bits of said code number word into a reversed word, determining the difference BM−B, forming said intermediate word with bits in the predetermined state as the BM−B most significant bits and with the B most significant bits of said reversed word as the B least significant bits.

16. The method of claim 15, wherein the intermediate word is formed by shifting the B most significant bits of said reversed word by BM−B positions toward the least significant bits.

17. The method of claim 12 further including reversing the order of the bits of said code number word into a reversed word, determining the difference BM−B, shifting the B most significant bits of said reversed word by BM−B positions toward the least significant bits; and forming said intermediate word with bits in the predetermined state as the BM−B most significant bits and with the B most significant bits of said reversed word as the B least significant bits, wherein the intermediate word is formed by the B most significant bits of said reversed word.

18. The method of claim 16, wherein BM=9, and B=0 and B=1 are prohibited values, and said difference is determined by inverting the state of the bits of said word representative of the number allocated to said number of code elements into a shift parameter word on which the shifting step is performed.

19. The method of claim 12, further comprising performing a binary-non-return to zero conversion on the code elements resulting from the said EXCLUSIVE-OR operation.
